(19) United States
(12) Patent Application Publication
(10) Pub. No.: US 2014/0098167 A1
(43) Pub. Date: Apr. 10, 2014

(54) METHOD OF HIGH-SPEED PRINTING FOR IMPROVING OPTICAL DENSITY IN PIGMENT-BASED INKS

(71) Applicant: ZAMTEC LIMITED, Dublin (IE)

(72) Inventors: Steven Adam Bernard, North Ryde (AU); Roger Michael Davey, North Ryde NSW (AU); Adrian Peter Bisson, North Ryde NSW (AU)

(73) Assignee: ZAMTEC LIMITED, Dublin (IE)

(21) Appl. No.: 14/048,578

(22) Filed: Oct. 8, 2013

Related U.S. Application Data
(60) Provisional application No. 61/711,598, filed on Oct. 9, 2012.

(51) Int. Cl. B41J 2/21

(52) U.S. Cl. CPC B41J 2/2114
USPC 347/96

(57) ABSTRACT

A method of inkjet printing includes the steps of: (a) moving a substrate past a printhead; (b) printing a pigment-based ink onto the substrate from a first color channel of the printhead; and (c) overprinting a fixer ink onto the pigment-based ink from a second color channel of the printhead. The fixer ink is overprinted onto the pigment-based ink within a period of less than 5 ms.

### FIELD OF THE INVENTION

This invention relates to inkjet printing and methods for improving print quality. It has been developed primarily for improving the optical density of pigment-based inks printed using high-speed printers.

### BACKGROUND OF THE INVENTION

The present Applicant has developed high-speed Memjet® printers employing self-cooling thermal bubble-forming printheads or thermal bend-actuated printheads. The Applicant's thermal bubble-forming printheads include those with suspended heater elements (as described in, for example, U.S. Pat. No. 6,755,509; U.S. Pat. No. 7,246,886; U.S. Pat. No. 7,401,910; and U.S. Pat. No. 7,658,977, the contents of which are incorporated herein by reference) and those with embedded heater elements (as described in, for example, U.S. Pat. No. 7,377,623; U.S. Pat. No. 7,431,431; U.S. Pat. No. 2006/250453; and U.S. Pat. No. 7,491,911, the contents of which are incorporated herein by reference). The Applicant's thermal bend-actuated printheads typically have movable paddles defined in a nozzle plate of the printhead (as described in, for example, U.S. Pat. No. 7,926,915; U.S. Pat. No. 7,669,967; and US 2011/0050806, the contents of which are incorporated herein by reference).

The Applicant Memjet® printheads are characterized by a high speed, high nozzle density and low drop volumes. Typically, a nozzle pitch between adjacent nozzles in a row is about 32 microns. A key advantage of Memjet® printheads is the relatively narrow print zone resulting from integration of a plurality of color planes on each printhead integrated circuit. The color planes of the Memjet® printhead are spaced closely together, which minimizes alignment problems during dot-on-dot printing. By contrast, widely spaced color planes necessitate complex media feed mechanisms to achieve proper alignment, adding to the complexity of other known pagewidth printing systems (e.g. HP Edgeline®), as well as lengthening the time interval between ejected ink droplets.

Typically, a distance between nozzles rows from neighboring color planes in a Memjet® printhead is in the range of 25 to 200 microns or 50 to 100 microns. The combination of high print speeds (of the order of 60 pages per minute) and closely spaced color planes is a reason why the Memjet® printhead technology has often been referred to as “waterfall” printhead technology. In other words, the printhead ejects ink in the manner of waterfall as paper is continuously fed beneath the printhead in one pass. Typically, during dot-on-dot printing, the period of time between a first dot and an overprinted second dot striking a page is less than 5 ms.

Therefore, in contrast with conventional scanning inkjet technologies, individual ink droplets printed at the same position on a page (i.e. dot-on-dot printing) strike the page virtually simultaneously using Memjet® printheads. Drop volumes in Memjet® printheads are usually in the range of about 1 to 2 pL.

One of the challenges of inkjet printing is to maximize optical density, particularly in black inks used to print plain text. Usually, pigment-based black inks are preferred to dye-based black inks, because pigment-based inks typically have a higher optical density than dye-based inks.

It is known in the art to employ fixatives (or “fixer inks”) in order to improve the optical density of pigment-based inks Fixer inks typically contain metal salts, such as calcium salts, which trigger the aggregation of pigment molecules. However, other fixatives have been described in the art, such as amines, oligomeric amines and polymeric amines (e.g. polyethyleneimines), optionally in combination with metal salts (see, for example, U.S. Pat. No. 7,622,513; U.S. Pat. No. 7,246,896; U.S. Pat. No. 7,470,314 and U.S. Pat. No. 7,682,012). The aggregation of pigment molecules triggered by fixatives improves optically density, such that black inks appear blacker to the naked eye even when a same amount of black ink is printed on the page.

U.S. Pat. No. 7,682,012 describes a method of improving optical density in a single-pass printer, whereby a pigment ink is overprinted on a fixer within a time interval of about 50 ms. As described in U.S. Pat. No. 7,682,012, a greater drying time of underprinted fixer is generally associated with a greater improvement in optical density of overprinted ink, because the overprinted ink penetrates more into a wet substrate compared with a dry substrate. The prior art teaches that improvements in optical density are maximized when the drying time of underprinted fixer is maximized.

The Applicant's “waterfall” printing technology presents unique challenges for improving inkjet print quality at high speeds where dot-on-dot printing occurs on a timescale of less than 5 ms. One solution for optimizing optical density would be to introduce a customized fixer printhead upstream of a Memjet® printhead to allow sufficient drying time for underprinted fixer. Nevertheless, it would be desirable to optimally improve black optical density during high speed printing without introducing a customized upstream fixer printhead.

### SUMMARY OF THE INVENTION

In a first aspect, there is provided a method of inkjet printing comprising the steps of:
(a) moving a substrate past a printhead;
(b) printing a pigment-based ink onto the substrate from a first color channel of the printhead; and
(c) overprinting a fixer ink onto the pigment-based ink from a second color channel of the printhead,
   wherein the fixer ink is overprinted onto the pigment-based ink within a period of less than 5 ms.

The method according to the first aspect is based on the surprising observation that the optical density of printed pigment-based black inks is significantly improved when overprinting fixer compared with underprinting fixer in the Applicant's Memjet® printheads. The teaching of the prior art is that underprinting fixer and lengthening fixer drying times provides maximum optical densities. Alternatively, it might be expected that, since ink droplets strike the page virtually simultaneously during high-speed printing, there would be no difference between underprinting and overprinting the fixer ink because there is no opportunity for drying of either the fixer ink or the pigment-based ink. Nevertheless, an appreciable and significant improvement in optical density was observed when overprinting the fixer ink, which confounds the teaching of the prior art which focuses on low-speed inkjet printing.

Optionally, the printhead is a stationary pagewidth printhead, and the substrate is fed past the printhead at a speed in the range of 0.1 to 3 meters per second. The high print speeds may be appropriate for high-speed SOHO printers (e.g. Lomond Evojet® Office printers), label printers, wideformat printers (e.g. wideformat printers described in US 2011/0025747, the contents of which are herein incorporated by reference) or commercial inkjet web-press type printers, (e.g. continuous web printers described in US Publication No. 2011/0043580, the contents of which are herein incorporated by reference).

Optionally, a distance between the first and second color channels in the printhead is in the range of 50 to 500 microns.

Optionally, the fixer ink comprises at least one fixer selected from the group consisting of: a metal salt and a polyamine. However, the present invention is not limited to any particular type of fixer, provided that it triggers aggregation of the pigment in the pigment-based ink.

Optionally, the metal salt is a calcium salt and the polyamine is polyethyleneimine.

Optionally, the fixer ink comprises a colorant selected from the group consisting of: dyes and pigments.

Optionally, the pigment-based ink comprises a self-dispersing pigment, such as a surface-modified pigment. Alternatively, the pigment-based may comprises a conventional pigment and a dispersant.

Optionally, the pigment-based ink comprises a black pigment.

Optionally, the fixer ink is overprinted onto the pigment-based ink within a period in the range of 0.1 to 1.5 ms

In a second aspect, there is provided an inkjet printer comprising:
a stationary printhead having a first color channel for ejecting a fixer ink and a second color channel for ejecting a pigment-based ink; and
a feed mechanism for feeding a substrate past the printhead,
   wherein the printer is configured for overprinting the fixer ink onto the pigment-based ink within a period of less than 5 ms.

As used herein, the term “pigment-based ink” refers to any inkjet ink comprising a pigment dispersed in an ink vehicle. The pigment-based ink may comprise a self-dispersing pigment, such as a surface-modified pigment. Alternatively, the pigment-based ink may comprise a conventional pigment and a dispersant, as known in the art.

As used herein, the term “fixer ink” refers to an ejectable ink vehicle comprising a fixer. The fixer ink may comprise no colorants. Alternatively, the fixer ink may comprise a colorant, such as a dye or pigment. In the case where the fixer ink comprises a pigment, the dispersed pigment should be stable with respect to aggregation in the presence of the fixer.

As used herein, the term “fixer” refers to any substance, or combination of substances, capable of triggering aggregation a pigment. Examples of typical fixers include metals salts, such as calcium salts, and polyalkylamines, such as polyethyeleneimine.

### BRIEF DESCRIPTION OF THE DRAWINGS

Various embodiments of the present invention will now be described by way of example only with reference to the accompanying drawings, in which:

FIG. 1 is a plan view of a printhead comprised of abutting printhead integrated circuits;

FIG. 2 is plan view of a single printhead integrated circuit;

FIG. 3 shows schematically the arrangement of color planes and nozzle rows in the printhead integrated circuit shown in FIG. 2;

FIG. 4 is a magnified front perspective view of the printhead integrated circuit shown in FIG. 2;

FIG. 5 is a magnified rear perspective view of the printhead integrated circuit shown in FIG. 2;

FIG. 6 is a cutaway perspective through one color plane of the printhead integrated circuit shown in FIG. 2;

FIG. 7 is an exploded perspective view of a printhead assembly;

FIG. 8 is a plan view of fluidic connections to a printhead integrated circuit in the printhead assembly shown in FIG. 7;

FIG. 9 is a magnified view of the fluidic connection shown in FIG. 8;

FIG. 10 is a perspective view of a printhead cartridge;

FIG. 11 is a perspective view of the printhead cartridge shown in FIG. 10 with a protective casing removed;

FIG. 12 is an exploded perspective view of the printhead cartridge shown in FIG. 10;

FIG. 13 is a front perspective of a print engine with an installed printhead cartridge;

FIG. 14 is a front perspective of the print engine shown in FIG. 13 with the printhead cartridge removed;

FIG. 15 is a rear perspective the print engine shown in FIG. 13 including ink delivery components; and

FIG. 16 is a schematic overview of an ink delivery system for a inkjet printer.

### DETAILED DESCRIPTION OF THE INVENTION

The present invention is particularly suitable for use with the Applicant's Memjet® printheads, which achieve dot-on-dot printing on a timescale of less than 5 milliseconds.

### Pagewidth Printhead and Printer

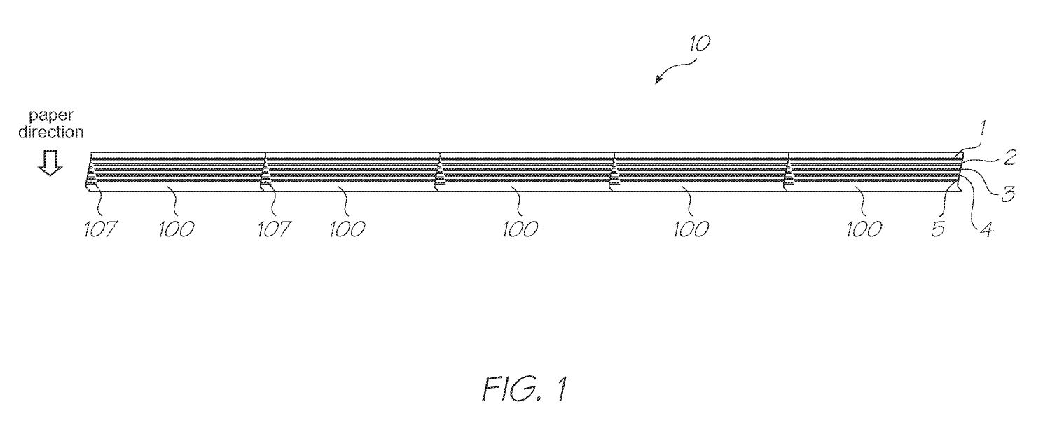

Referring to FIG. 1, the Memjet® printhead 10 comprises a plurality of printhead integrated circuits (ICs) 100 butted end-on-end. Each printhead integrated circuit 100 typically has a length of about 20 mm. The number of butting printhead ICs 100 in a particular printhead will, of course, depend on the type of printer. For example, a 4″ printhead (suitable for photo or label printing) typically comprises five abutting ICs 100, as shown in FIG. 1. An A4 printhead (suitable for home and office use) typically comprises eleven abutting printhead ICs 100. A wideformat printer may comprise a plurality of A4 printheads in a staggered arrangement across a width of a page (see, for example, US 2011/0025747). The present invention is not limited to any particular width of printhead.

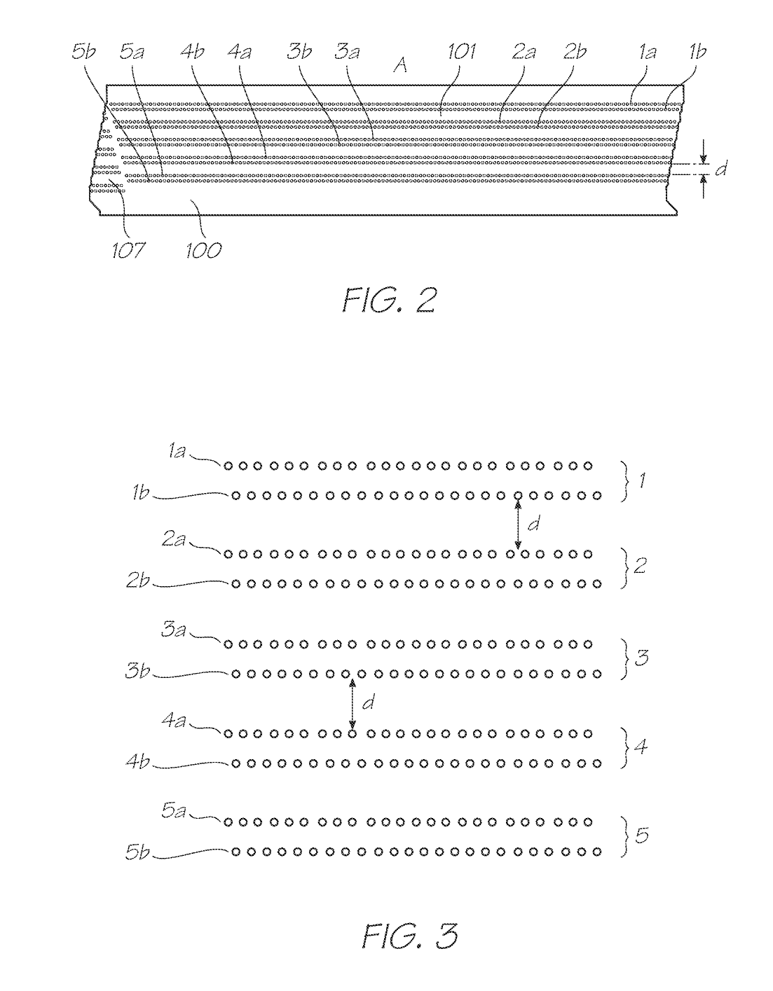

The Memjet printhead 10 is comprised five color planes 1, 2, 3, 4 and 5 spaced apart transversely across the printhead in a paper feed direction. Each color plane comprises a pair of offset nozzle rows, which extend longitudinally along the length of the printhead. For example, the color plane 1 comprises nozzle rows 1a and 1b, as shown more clearly in FIG. 2. Likewise, color plane 2 comprises nozzle rows 2a and 2b, color plane 3 comprises nozzle rows 3a and 3b etc. Each color plane is characterized in that all nozzles 102 in the same color plane are supplied with and eject the same ink. Each of the five color planes 1, 2, 3, 4 and 5 of the printhead 10 may eject a different colored ink. However, the Memjet® printhead 10 usually incorporates at least some redundancy in the color planes. For example, there may be a two color planes ejecting black ink, while the other three color planes eject cyan, magenta and yellow ink, respectively. Redundancy helps to improve overall print quality by improving optical density and minimizing the visual impact of defective nozzles (see U.S. Pat. No. 7,465,017). Redundant color channels may receive ink from the same bulk ink reservoir of the printer or from separate ink reservoirs.

In the present invention, one of the color planes ejects the pigment-based ink while another color plane ejects the fixer ink. The fixer ink should be ejected from a color plane positioned downstream of the color plane ejecting the pigment-based ink in order to achieve overprinting of the fixer ink within a time period of less than 5 ms. For example, the pigment-based ink may be ejected from color plane 2 and the fixer ink ejected from color plane 4. With this arrangement, when printing at about 60 pages per minute, the time period between printing of the pigment-based ink and overprinting of the fixer ink is about 1 ms. However, the fixer ink may be printed from a neighboring color plane or a more separated color plane provided that it overprints onto the pigment-based ink within a time period of less than 5 ms (e.g. 0.1 to 5 ms or 0.2 to 2.5 ms).

Referring to FIG. 3, a distance d between nozzle rows from neighboring color planes (e.g. nozzle row 1b and 2a) is about 73 microns in the Memjet® printhead 10. A nozzle pitch between neighboring nozzles in the same nozzle row is 31.75 microns. The pair of nozzle rows in a same color plane are offset by a distance of 15.875 microns along a longitudinal axis of the printhead, such that one nozzle row prints ‘even’ dots of a line and the other nozzle row prints ‘odd dots’ of a line. In this way, the Memjet printhead achieves a printed dot-spacing of about 15.875 microns in each line of print, or about 1600 dpi.

Referring to FIGS. 1, 2 and 4, it will be seen that in regions where abutting printhead ICs 100 are joined, there is a displaced (or dropped) triangle 107 of nozzle rows. These dropped triangles 107 allow printhead ICs 100 to be joined, whilst effectively maintaining a constant nozzle pitch along each row. This arrangement also ensures that more silicon is provided at the edge of each printhead IC 100 to ensure sufficient linkage between butting ICs. A timing device (not shown) is used to delay firing nozzles 102 in the dropped triangles 107, as appropriate. Whilst control of the operation of the nozzles 102 is performed by a printhead controller (“SoPEC”) device, compensation for the dropped rows of nozzles may be performed by CMOS circuitry in the printhead, or may be shared between the printhead and the SoPEC device. A full description of the dropped nozzle arrangement and control thereof is contained in U.S. Pat. No. 7,390,071, the contents of which are herein incorporated by reference.

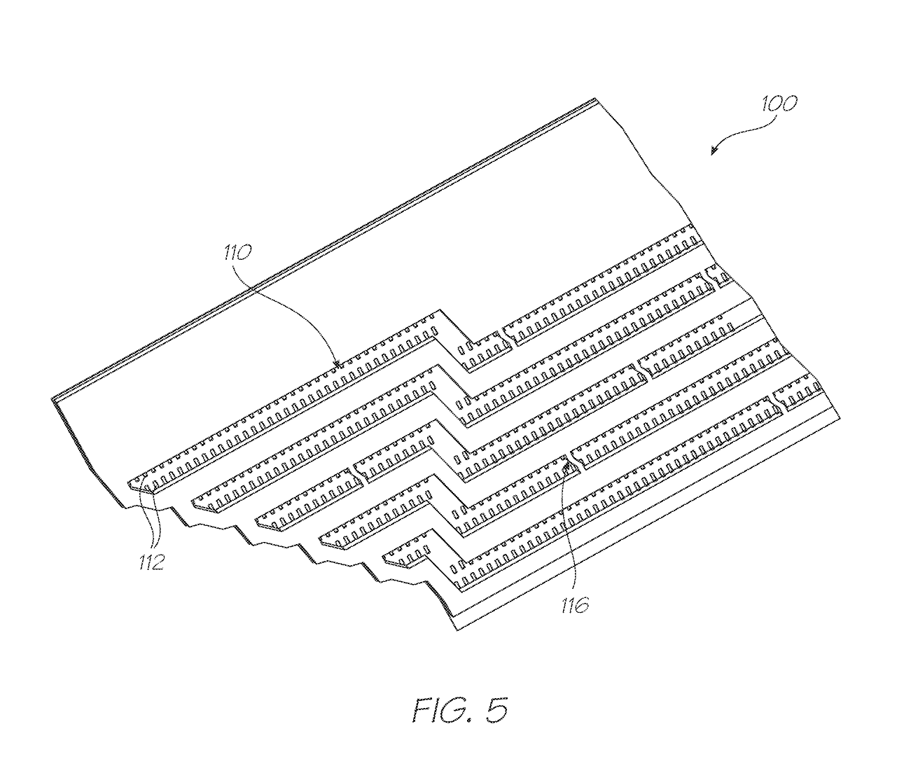

Referring now to FIG. 5, there is shown an opposite backside face of the printhead integrated circuit 100. Ink supply channels 110 are defined in the backside of the printhead IC 100, which extend longitudinally along the length of the printhead IC. These longitudinal ink supply channels 110 meet with nozzle inlets 112, which fluidically communicate with the nozzles 102 in the frontside. Each of the five ink supply channels 110 corresponds with one of the color planes of the printhead, such that one ink supply channel supplies ink to the pair of nozzle rows contained in one color plane.

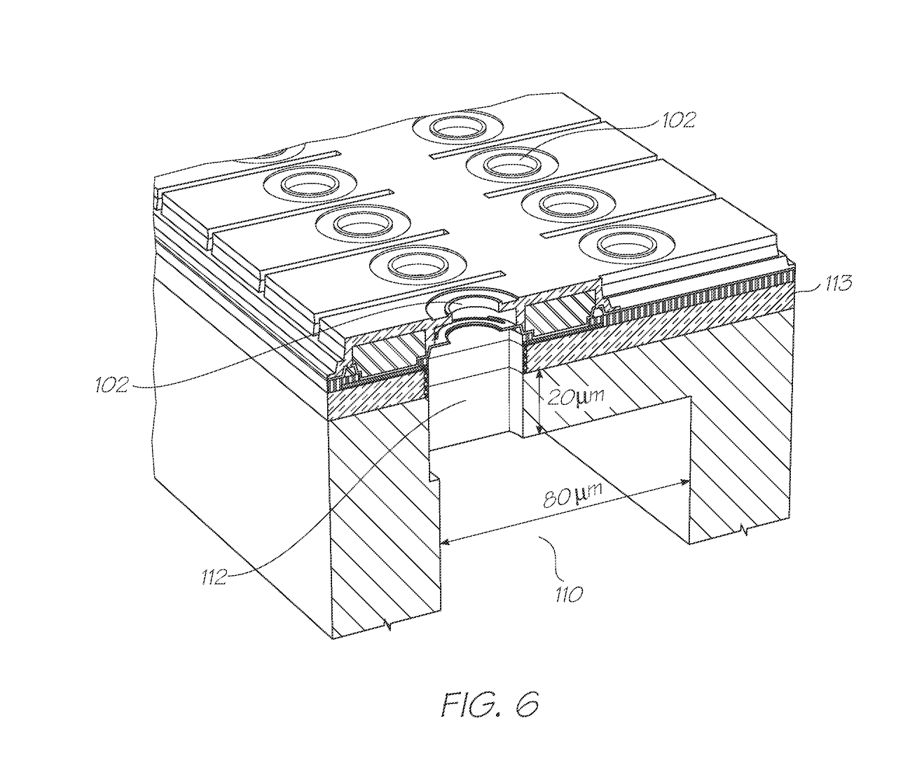

FIG. 6 is a cutaway perspective of part of a printhead IC showing fluidic communication between a nozzle 102, a nozzle inlet 112 and a backside ink supply channel 110. As shown in FIG. 6, the nozzle 102 ejects ink via a suspended bubble-forming heater element. However, other types of nozzle actuation are equally suitable for use in the printheads described herein. The present Applicant has developed a plethora of thermal bubble-forming printheads and thermal bend-actuated printheads. The Applicant's thermal bubble-forming printheads include those with suspended heater elements (as described in, for example, U.S. Pat. No. 6,755,509; U.S. Pat. No. 7,246,886; U.S. Pat. No. 7,401,910; and U.S. Pat. No. 7,658,977, the contents of which are incorporated herein by reference) and those with embedded heater elements (as described in, for example, U.S. Pat. No. 7,377,623; U.S. Pat. No. 7,431,431; US 2006/250453; and U.S. Pat. No. 7,491,911, the contents of which are incorporated herein by reference). The Applicant's thermal bend-actuated printheads typically have movable paddles defined in a nozzle plate of the printhead (as described in, for example, U.S. Pat. No. 7,926,915; U.S. Pat. No. 7,669,967; and US 2011/0050806, the contents of which are incorporated herein by reference).

Returning to FIG. 5, the longitudinally extending backside ink supply channels 110 are divided into sections by silicon bridges or walls 116. These walls 116 provide the printhead IC 100 with additional mechanical strength in a transverse direction relative to the longitudinal channels 110.

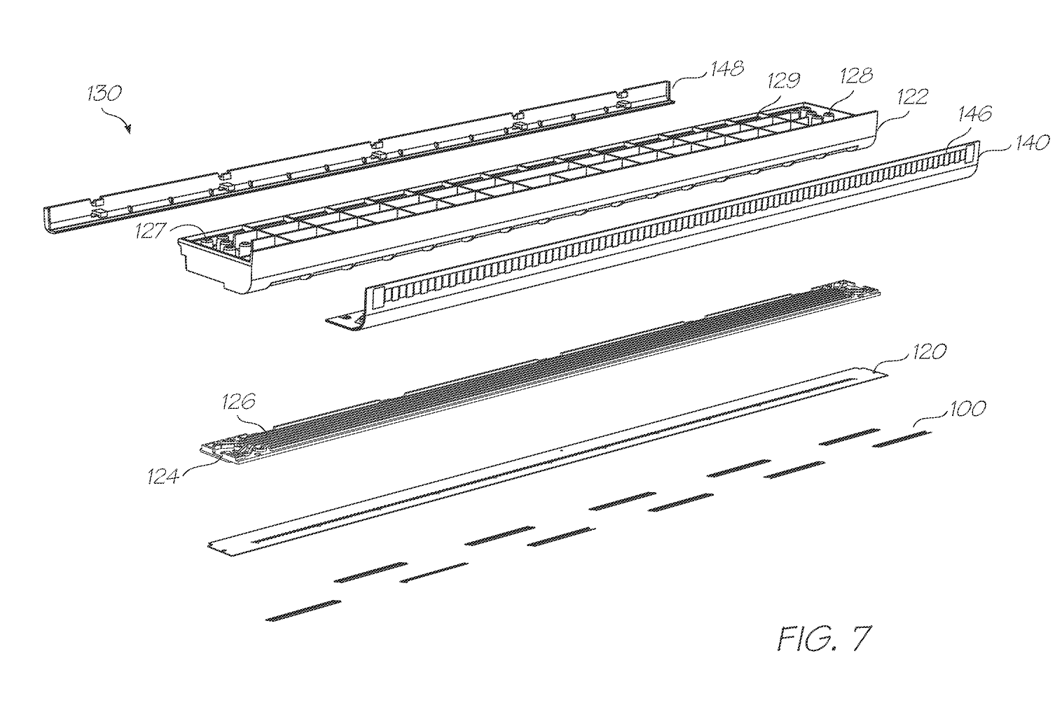

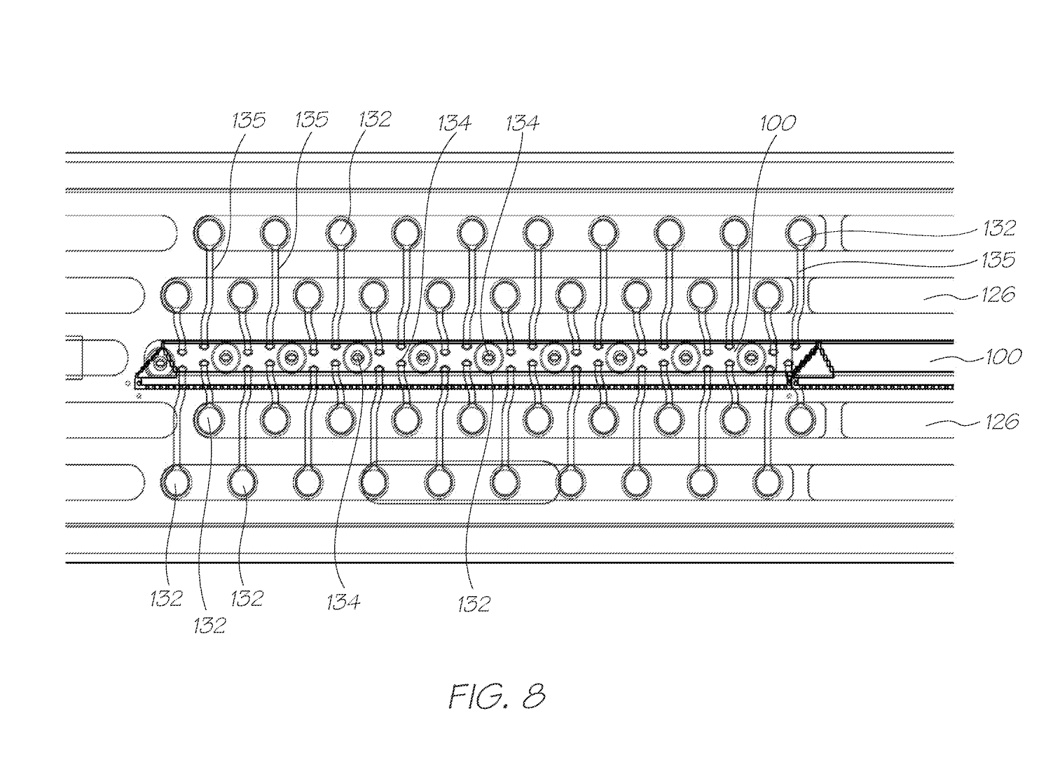

Ink is supplied to the backside of each printhead IC 100 via an ink supply manifold in the form a two-part LCP molding. Referring to FIGS. 7 to 10, there is shown an exploded view of an A4 printhead assembly comprising eleven printheads IC 100, which are attached to the ink supply manifold via an adhesive film 120.

The ink supply manifold comprises a main LCP molding 122 and an LCP channel molding 124 sealed to its underside. The printhead ICs 100 are bonded to the underside of the channel molding 124 with the adhesive IC attach film 120. The upperside of the LCP channel molding 124 comprises five LCP main channels 126, which connect with respective ink inlets 127 and ink outlets 128 in the main LCP molding 122. The ink inlets 127 and ink outlets 128 fluidically communicate with ink tanks and an ink supply system, which supplies ink to the printhead at a predetermined hydrostatic pressure.

The main LCP molding 122 has a plurality of air cavities 129, which communicate with the LCP main channels 126 defined in the LCP channel molding 124. The air cavities 129 serve to dampen ink pressure pulses in the ink supply system.

Referring to FIG. 8, at the base of each LCP main channel 126 are a series of ink supply passages 132 leading to the printhead ICs 100. The adhesive film 120 has a series of laser-drilled supply holes 134 so that the backside of each printhead IC 100 is in fluid communication with the ink supply passages 132.

The ink supply passages 132 are arranged in a series of five rows. A middle row of ink supply passages 132 feed ink directly to the backside of the printhead IC 100 through laser-drilled holes 134, whilst the outer rows of ink supply passages 132 feed ink to the printhead IC via micromolded channels 135, each micromolded channel terminating at one of the laser-drilled holes 134.

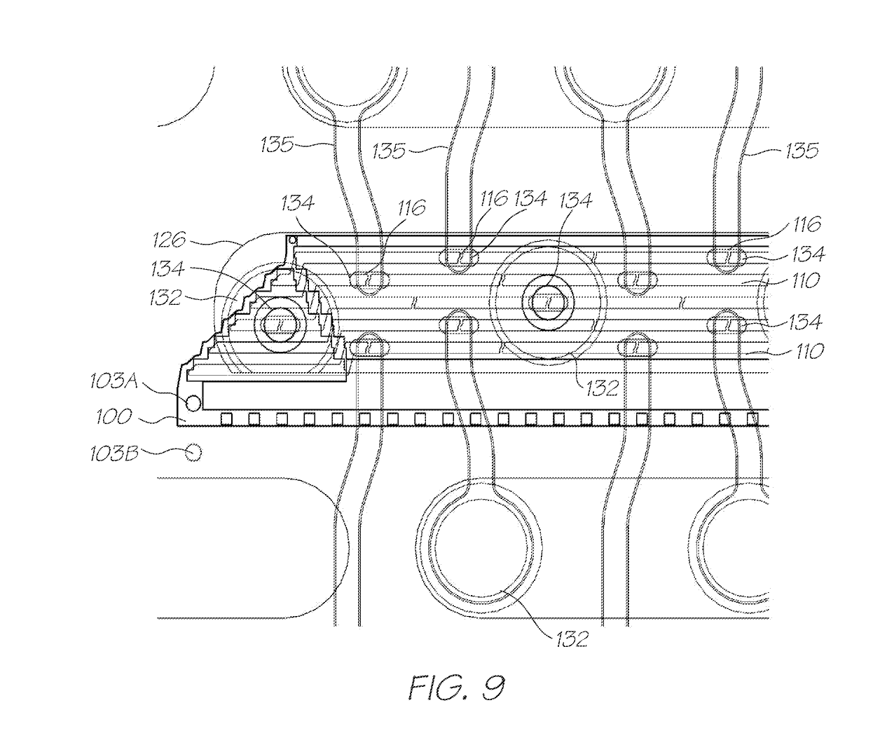

FIG. 9 shows in more detail how ink is fed to the backside ink supply channels 110 of the printhead ICs 100. Each laser-drilled hole 134, which is defined in the adhesive film 120, is aligned with a corresponding ink supply channel 110. Generally, the laser-drilled hole 134 is aligned with one of the transverse walls 116 in the channel 110 so that ink is supplied to a channel section on either side of the wall 116. This arrangement reduces the number of fluidic connections required between the ink supply manifold and the printhead ICs 100. In some embodiments, the transverse walls 116 may be absent from the channels 110.

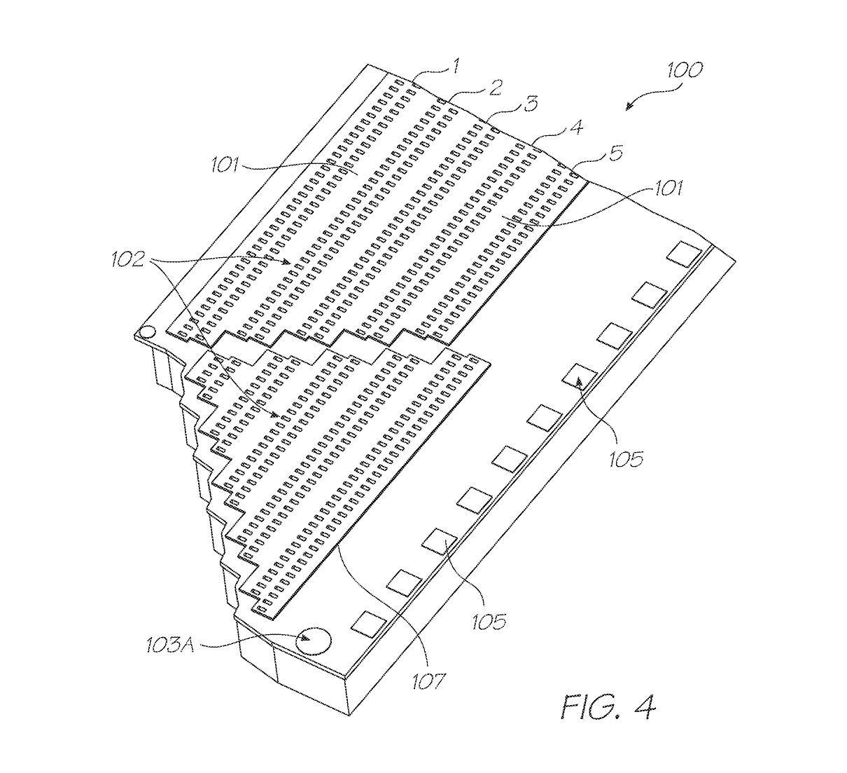

To aid in positioning of the ICs 100 correctly, fiducials 103A are provided on the surface of the ICs 100 (see FIG. 4). The fiducials 103A are in the form of markers that are readily identifiable by appropriate positioning equipment to indicate the true position of the IC 100 with respect to a neighboring IC. The adhesive film 120 has complementary fiducials 103B, which aid alignment of each printhead IC 100 with respect to the adhesive film during bonding of the printhead ICs to the ink supply manifold. The fiducials 103A and 103B are strategically positioned at the edges of the ICs 100 and along the length of the adhesive IC attach film 120. Returning now to FIG. 4, the printhead IC 100 has a plurality of bond pads 105 extending along one of its longitudinal edges. The bond pads 105 provide a means for receiving data and/or power from the printhead controller (“SoPEC”) device to control the operation of the inkjet nozzles 102. The bond pads 105 are connected to an upper CMOS layer of the printhead IC 100. As shown in FIG. 6, each MEMS nozzle assembly is formed on a CMOS layer 113, which contains the requisite logic and drive circuitry for firing each nozzle.

Referring again to FIG. 7, a flex PCB 140 bends around the main LCP molding 122 and has terminals wirebonded to the bond pads 105 of the printhead ICs 100. Wirebonding arrangements between the flex 140 PCB and the bond pads 105 are described in more detail in U.S. Pat. No. 7,824,013, the contents of which is herein incorporated by reference.

A paper guide 148 is mounted on an opposite side of the LCP molding 122, with respect to the flex PCB 140, and completes the printhead assembly 130. In some embodiments, the paper guide 148 may be absent.

The printhead assembly 130 is designed as part of a user-replaceable printhead cartridge 20, which can be removed from and replaced in a print engine of an inkjet printer. Hence, the flex PCB 140 has a plurality of contacts 146 enabling power and data connections to electronics, including the SoPEC device, in the printer body.

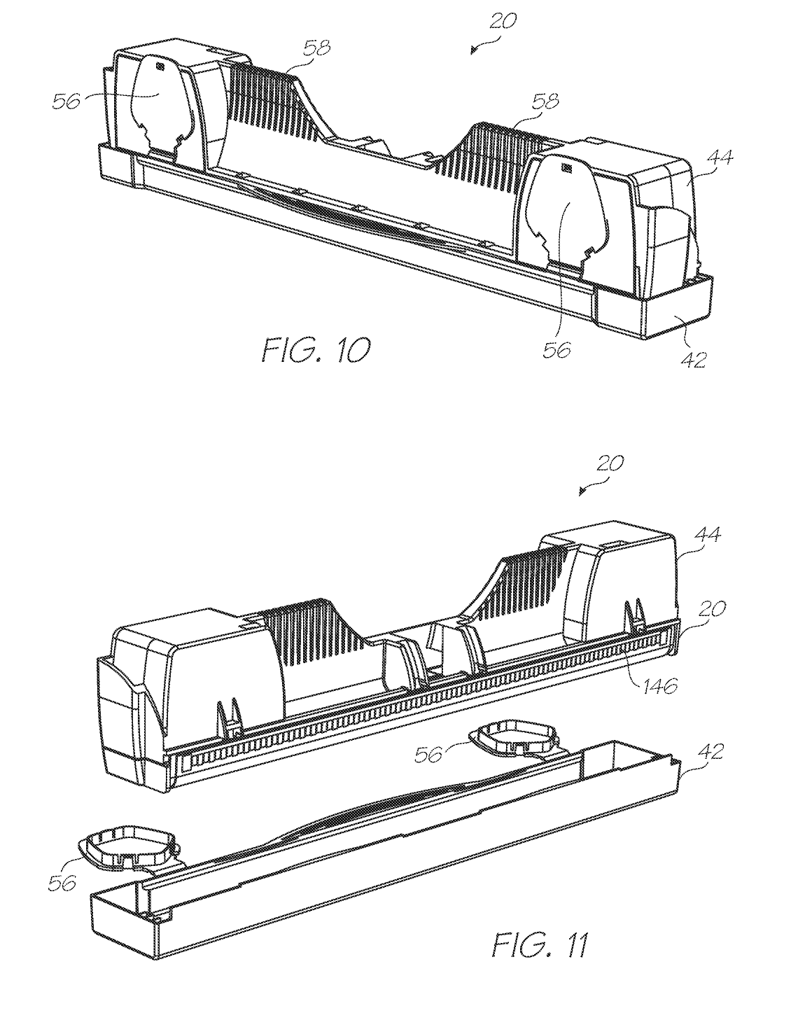

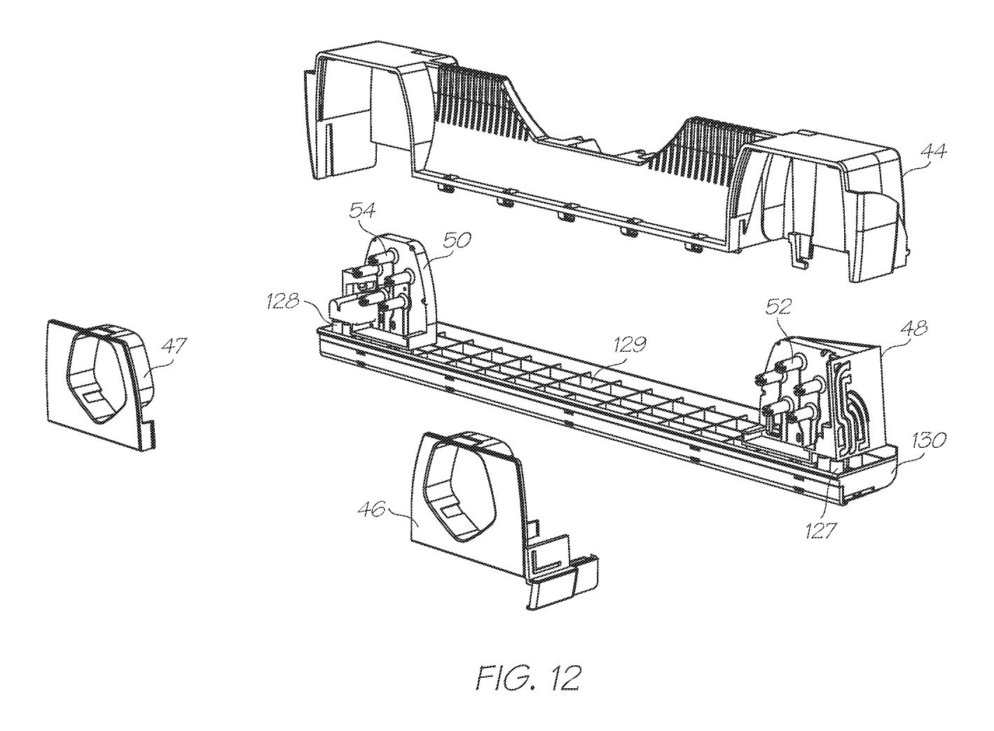

FIG. 10 is a perspective of the complete printhead cartridge 20. The printhead cartridge 20 has a top molding 44 and a removable protective cover 42. The top molding 44 has a central web for structural stiffness and to provide textured grip surfaces 58 for manipulating the cartridge during insertion and removal. The base portion of the protective cover 42 protects the printhead ICs 100 and line of contacts 146 prior to installation in the printer. Caps 56 are integrally formed with the base portion and cover ink inlets and outlets (see 54 and 52 of FIG. 12).

FIG. 11 shows the printhead cartridge 20 with its protective cover 42 removed to expose the printhead ICs 100 (not shown in FIG. 11) on a bottom surface and the line of contacts 146 on a side surface.

FIG. 12 is a partially exploded perspective of the printhead assembly 20. The top cover 44 has been removed to reveal the inlet manifold 48 and the outlet manifold 50. The inlet and outlet shrouds 46 and 47 have been removed to expose the five inlet and outlet spouts (52 and 54). The inlet and outlet manifolds 48 and 50 form a fluid connection between each of the individual inlets and outlets and a corresponding main channel (see 126 in FIG. 7) in the LCP channel molding 124.

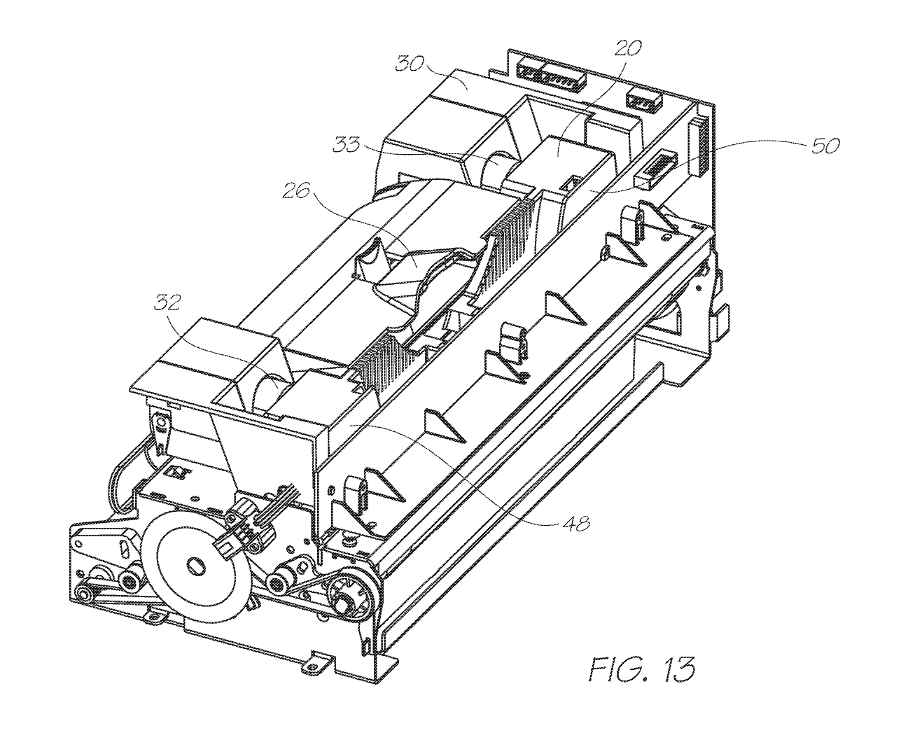

FIG. 13 shows a print engine 30 of the type that uses the printhead cartridge 20. The print engine 30 is the internal structure of an inkjet printer and therefore does not include any external casing, ink tanks or media feed and collection trays. The printhead cartridge 20 is inserted and removed by the user lifting and lowering a latch 26. The print engine 30 forms an electrical connection with 146 contacts on the printhead cartridge 20. The print engine forms a fluid coupling via an inlet socket 32 and an outlet socket 33, which are connected to the inlet manifold 48 and outlet manifold 50 of the printhead cartridge 20.

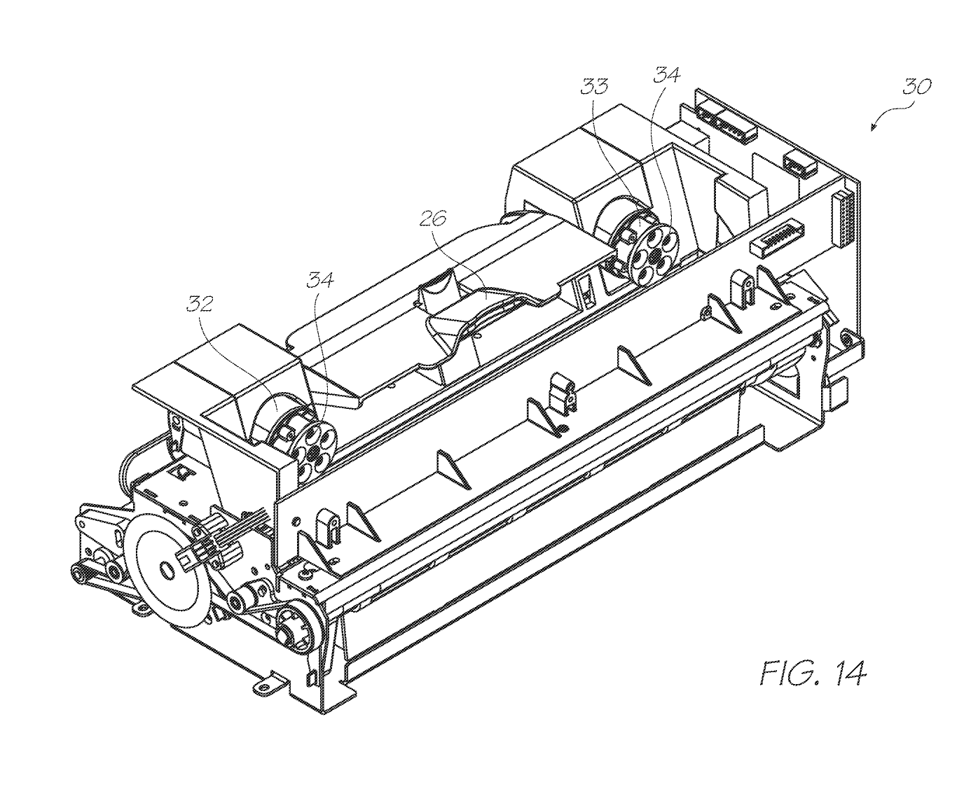

FIG. 14 shows the print engine 30 with the printhead cartridge removed to reveal the apertures 34 in each of the sockets 32 and 33. Each aperture 34 receives one of the spouts 52 (see FIG. 12) on the inlet and outlet manifolds Ink tanks have an arbitrary position and configuration but simply connect to hollow spigots 124 (not shown) at the rear of the sockets 32 in the inlet coupling. A spigot at the rear of socket in the outlet coupling 33 leads to a waste ink outlet.

Connections of ink tanks to the inlet spouts 52 of the inlet manifold 48 (via the inlet socket 32) determine the plumbing arrangement of color planes in the printhead. For example, each black color plane of the printhead may have a respective black ink tank, one containing the pigment-based ink and the other containing the fixer ink.

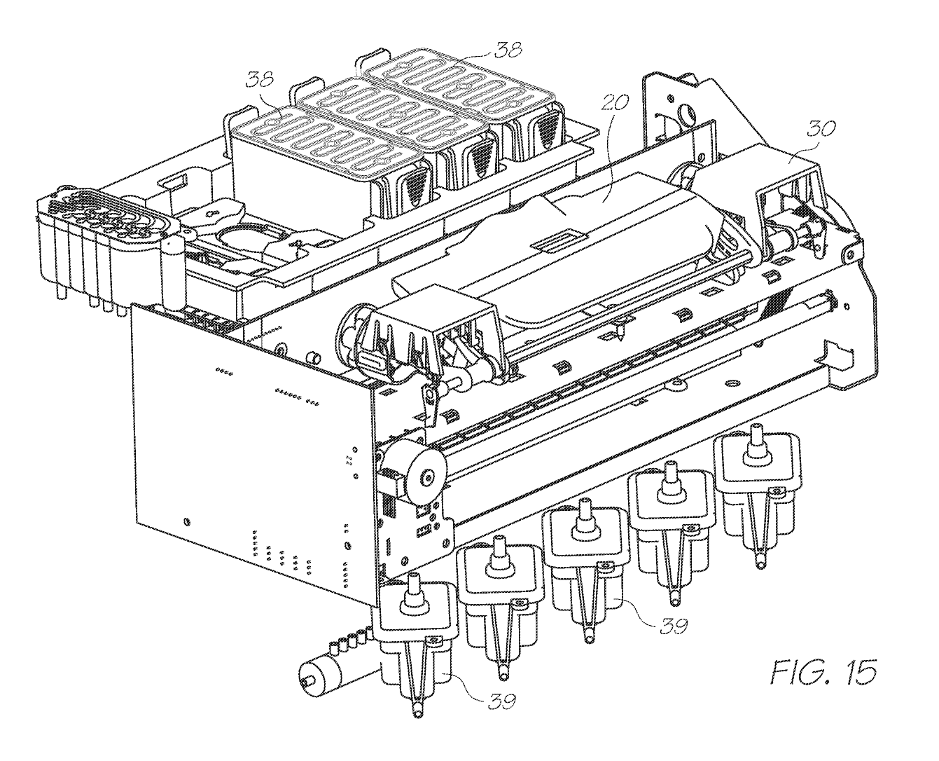

FIG. 15 shows the print engine 30 with an installed bank of user-replaceable ink tanks 38 and corresponding pressure-regulating chambers 39 for regulation of a hydrostatic pressure of ink supplied to the printhead. Although fluidic connections between the various components are not shown in FIG. 15, it will be appreciated that these connections are made with suitable hoses in accordance with the fluidics system described in, for example, U.S. application Ser. No. 12/062,514, the contents of which are herein incorporated by reference.

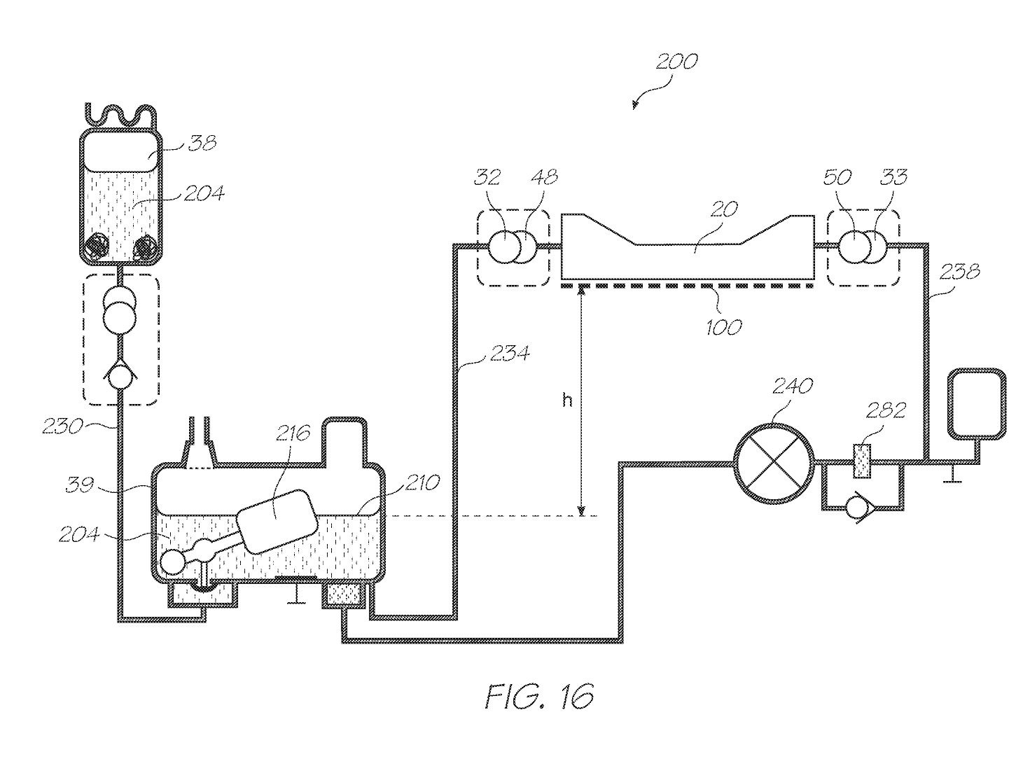

FIG. 16 shows schematically a fluidics system 200 of the printer engine shown in FIG. 15. The pressure-regulating chamber 39 supplies ink 204 to the ink inlet 48 of the printhead cartridge 20 via an upstream ink line 234. The pressure-regulating chamber 39 is positioned below the printhead cartridge 20 and maintains a predetermined set level 210 of ink therein by means of a float valve 216.

Ink 204 is supplied to the pressure-regulating chamber 39 by the ink tank 38 positioned at any height h above the set level 210. The ink tank 38 is typically a user-replaceable ink cartridge, which connects with an ink supply line 230 when installed in the printer. The ink supply line 230 provides fluidic communication between the ink reservoir 38 and an inlet port of the pressure-regulating chamber 39.

The ink outlet 50 of the printhead cartridge 20 is connected to a downstream ink line 238, which feeds back to a return port of the chamber 39. The downstream ink line comprises an inline a filter 282 and ink pump 240 for controlling priming and de-priming operations.

### Pigment-Based Inks

The present invention utilizes pigment-based inks, which may comprise either a conventional pigment or a self-dispersing pigment in an ink vehicle.

Examples of conventional pigments are carbon black, Cadmium Red, Molybdenum Red, Chrome Yellow, Cadmium Yellow, Titan Yellow, chromium oxide, Viridian, Titan Cobalt Green, Ultramarine Blue, Prussian Blue, Cobalt Blue, diketopyrrolo-pyrrole, anthraquinone, benzimidazolone, anthrapyrimidine, azo pigments, phthalocyanine pigments (including naphthlocyanine pigments), uinacridone pigments, isoindolinone pigments, dioxazine pigments, indanthrene pigments, perylene pigments, perinone pigments, thioindigo pigments, quinophthalone pigments, and metal complex pigments.

Some specific examples of suitable pigments include: Cyan COJ450 (Cabot), D71C and D75C (Diamond Dispersions); Magenta COJ465 (Cabot), D71M, D75M, D71PV19 (Diamond Dispersions), Hostajet Magenta E-PT VP2690 and Hostajet Magenta E5B-PT VP3565 (Clariant); Yellow COJ270 and COJ470 (Cabot), or D71Y, D71Y155, D75Y (Diamond Dispersions) and Hostajet Yellow 4G-PT VP2669 (Clariant); Black CW1, CW2, CW3 (Orient) or COJ200, COJ300, COJ400, IJX455 (Cabot) or SDP1000, SDP2000 (Sensient), or D71K, D75K, D77K, D8OK (Diamond Dispersions) and Hostajet Black O-PT (Clariant); Red D71R (Diamond Dispersions); Blue D71B (Diamond Dispersions).

Conventional pigments are usually stabilized with respect to dispersion in an ink vehicle using dispersants. The skilled person will be aware of many different types of dispersants, as known in the art. Typical dispersants include acrylic polymers and/or styrene-acrylic copolymers. Specific examples of dispersants are described in, for example, U.S. Pat. No. 5,085,698; EP-A-0556649 and U.S. Pat. No. 5,231,131, the contents of which are herein incorporated by reference.

Alternatively, the pigments may be self-dispersing pigments, which are typically surface-modified pigments. The surface modification of the pigment may be either anionic group or a cationic. Typical surface-modifying groups are carboxylate and sulfonate groups. However, other surface-modifying groups may also be used, such as anionic phosphate groups or cationic ammonium groups.

Specific examples of aqueous surface-modified pigment dispersions include: Sensijet® Black SDP 2000 (available from Sensient Colors Inc.) and CAB-O-JET® 200, 300, 250C, 260M and 270Y (available from Cabot Corporation).

The average particle size of pigment particles in inkjet inks is optionally in the range of 50 to 500 nm.

Pigments may be employed either individually or as a combination of two or more thereof.

Ink vehicles for inkjet inks will be well known to the person skilled in the art and the ink vehicles used in the present invention are not particularly limited. The ink vehicles used in the present invention are typically conventional aqueous ink vehicles comprising at least 40 wt % water, at least 50 wt % water or at least 60 wt % water. Usually, the amount of water present in the inkjet ink is in the range of 50 wt % to 90 wt %, or optionally in the range of 60 wt % to 80 wt %.

Aqueous inkjet inks compositions are well known in the literature and, in addition to water, may comprise other components, such as co-solvents (including humectants, penetrants, wetting agents etc.), surfactants, biocides, sequestering agents, pH adjusters, viscosity modifiers, etc.

Co-solvents are typically water-soluble organic solvents. Suitable water-soluble organic solvents include C₁₋₄ alkyl alcohols, such as ethanol, methanol, butanol, propanol, and 2-propanol; glycol ethers, such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-isopropyl ether, diethylene glycol mono-isopropyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-isopropyl ether, dipropylene glycol monomethyl ether, dipropylene glycol monoethyl ether, dipropylene glycol mono-n-propyl ether, dipropylene glycol mono-isopropyl ether, propylene glycol mono-n-butyl ether, and dipropylene glycol mono-n-butyl ether; formamide, acetamide, dimethyl sulfoxide, sorbitol, sorbitan, glycerol monoacetate, glycerol diacetate, glycerol triacetate, and sulfolane; or combinations thereof.

Other useful water-soluble organic solvents, which may be used as co-solvents, include polar solvents, such as 2-pyrrolidone, N-methylpyrrolidone, ε-caprolactam, dimethyl sulfoxide, sulfolane, morpholine, N-ethylmorpholine, 1,3-dimethyl-2-imidazolidinone and combinations thereof.

The inkjet ink may contain a high-boiling water-soluble organic solvent as a co-solvent, which can serve as a wetting agent or humectant for imparting water retentivity and wetting properties to the ink composition. Such a high-boiling water-soluble organic solvent includes one having a boiling point of 180° C. or higher. Examples of the water-soluble organic solvent having a boiling point of 180° C. or higher are ethylene glycol, propylene glycol, diethylene glycol, pentamethylene glycol, trimethylene glycol, 2-butene-1,4-diol, 2-ethyl-1,3-hexanediol, 2-methyl-2,4-pentanediol, tripropylene glycol monomethyl ether, dipropylene glycol monoethyl glycol, dipropylene glycol monoethyl ether, dipropylene glycol monomethyl ether, dipropylene glycol, triethylene glycol monomethyl ether, tetraethylene glycol, triethylene glycol, diethylene glycol monobutyl ether, diethylene glycol monoethyl ether, diethylene glycol monomethyl ether, tripropylene glycol, polyethylene glycols having molecular weights of 2000 or lower, 1,3-propylene glycol, isopropylene glycol, isobutylene glycol, 1,4-butanediol, 1,3-butanediol, 1,5-pentanediol, 1,6-hexanediol, glycerol, erythritol, pentaerythritol and combinations thereof.

Other suitable wetting agents or humectants include saccharides (including monosaccharides, oligosaccharides and polysaccharides) and derivatives thereof (e.g. maltitol, sorbitol, xylitol, hyaluronic salts, aldonic acids, uronic acids etc.)

The inkjet ink may also contain a penetrant, as one of the co-solvents, for accelerating penetration of the aqueous ink into the recording medium. Suitable penetrants include polyhydric alcohol alkyl ethers (glycol ethers) and/or 1,2-alkyldiols. Examples of suitable polyhydric alcohol alkyl ethers are ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, ethylene glycol mono-n-propyl ether, ethylene glycol mono-isopropyl ether, diethylene glycol mono-isopropyl ether, ethylene glycol mono-n-butyl ether, diethylene glycol mono-n-butyl ether, triethylene glycol mono-n-butyl ether, ethylene glycol mono-t-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-isopropyl ether, dipropylene glycol monomethyl ether, dipropylene glycol monoethyl ether, dipropylene glycol mono-n-propyl ether, dipropylene glycol mono-isopropyl ether, propylene glycol mono-n-butyl ether, and dipropylene glycol mono-n-butyl ether. Examples of suitable 1,2-alkyldiols are 1,2-pentanediol and 1,2-hexanediol. The penetrant may also be selected from straight-chain hydrocarbon diols, such as 1,3-propanediol, 1,4-butanediol, 1,5-pentanediol, 1,6-hexanediol, 1,7-heptanediol, and 1,8-octanediol. Glycerol may also be used as a penetrant.

Typically, the amount of co-solvent present in the ink is in the range of about 5 wt % to 40 wt %, or optionally 10 wt % to 30 wt %. A specific example of a co-solvent system, which may be used in the present invention, comprises ethylene glycol, 2-pyrrolidone and glycerol.

The inkjet ink may also contain one or more surface active agents (“surfactant”), such as an anionic surface active agent, a zwitterionic surface active agent, a nonionic surface active agent or mixtures thereof. Useful anionic surface active agents include sulfonic acid types, such as alkanesulfonic acid salts, α-olefinsulfonic acid salts, alkylbenzenesulfonic acid salts, alkylnaphthalenesulfonic acids, acylmethyltaurines, and dialkylsulfosuccinic acids; alkylsulfuric ester salts, sulfated oils, sulfated olefins, polyoxyethylene alkyl ether sulfuric ester salts; carboxylic acid types, e.g., fatty acid salts and alkylsarcosine salts; and phosphoric acid ester types, such as alkylphosphoric ester salts, polyoxyethylene alkyl ether phosphoric ester salts, and glycerophosphoric ester salts. Specific examples of the anionic surface active agents are sodium dodecylbenzenesulfonate, sodium laurate, and a polyoxyethylene alkyl ether sulfate ammonium salt.

Examples of zwitterionic surface active agents include N,N-dimethyl-N-octyl amine oxide, N,N-dimethyl-N-dodecyl amine oxide, N,N-dimethyl-N-tetradecyl amine oxide, N,N-dimethyl-N-hexadecyl amine oxide, N,N-dimethyl-N-octadecyl amine oxide and N,N-dimethyl-N-(Z-9-octadecenyl)-N-amine oxide.

Examples of nonionic surface active agents include ethylene oxide adduct types, such as polyoxyethylene alkyl ethers, polyoxyethylene alkylphenyl ethers, polyoxyethylene alkyl esters, and polyoxyethylene alkylamides; polyol ester types, such as glycerol alkyl esters, sorbitan alkyl esters, and sugar alkyl esters; polyether types, such as polyhydric alcohol alkyl ethers; and alkanolamide types, such as alkanolamine fatty acid amides. Specific examples of nonionic surface active agents are ethers such as polyoxyethylene nonylphenyl ether, polyoxyethylene octylphenyl ether, polyoxyethylene dodecylphenyl ether, polyoxyethylene alkylallyl ether, polyoxyethylene oleyl ether, polyoxyethylene lauryl ether, and polyoxyalkylene alkyl ethers (e.g. polyoxyethylene alkyl ethers); and esters, such as polyoxyethylene oleate, polyoxyethylene oleate ester, polyoxyethylene distearate, sorbitan laurate, sorbitan monostearate, sorbitan mono-oleate, sorbitan sesquioleate, polyoxyethylene mono-oleate, and polyoxyethylene stearate. Acetylene glycol surface active agents, such as 2,4,7,9-tetramethyl-5-decyne-4,7-diol; ethoxylated 2,4,7,9-tetramethyl-5-decyne-4,7-diol; 3,6-dimethyl-4-octyne-3,6-diol or 3,5-dimethyl-1-hexyn-3-ol, may also be used. Specific examples of nonionic surfactants, which may be used in the present invention, are Surfynol® 465 and Surfynol® 440 (available from Air Products and Chemicals, Inc)

The surfactant(s) are typically present in the aqueous inkjet ink in an amount ranging from 0.1 wt % to 2 wt %. As described above, the amount of surfactant in relatively low luminance inks is at least 0.4 wt. % greater than the amount of surfactant in relatively high luminance inks Typically, color inks have at least 0.4 wt. % more surfactant than black ink in a given ink set.

The aqueous inkjet ink may also include a pH adjuster or buffer, such as sodium hydroxide, potassium hydroxide, lithium hydroxide, sodium carbonate, sodium hydrogencarbonate, potassium carbonate, potassium hydrogencarbonate, lithium carbonate, sodium phosphate, potassium phosphate, lithium phosphate, potassium dihydrogenphosphate, dipotassium hydrogenphosphate, sodium oxalate, potassium oxalate, lithium oxalate, sodium borate, sodium tetraborate, potassium hydrogenphthalate, and potassium hydrogentartrate; ammonia; and amines, such as methylamine, ethylamine, diethylamine, trimethylamine, triethylamine, tris(hydroxymethyl)aminomethane hydrochloride, triethanolamine, diethanolamine, diethylethanolamine, triisopropanolamine, butyldiethanolamine, morpholine, propanolamine, 4-morpholineethanesulfonic acid and 4-morpholinepropanesulfonic acid (“MOPS”). The amount of pH adjuster, when present, is typically in the range of from 0.01 to 2 wt. % or 0.05 to 1 wt. %.

The aqueous inkjet ink may also include a biocide, such as benzoic acid, dichlorophene, hexachlorophene, sorbic acid, hydroxybenzoic esters, sodium dehydroacetate, 1,2-benthiazolin-3-one (“Proxel® GXL”, available from Arch Chemicals, Inc.), 3,4-isothiazolin-3-one or 4,4-dimethyloxazolidine. The amount of pH adjuster, when present, is typically in the range of from 0.01 to 2 wt. % or 0.05 to 1 wt. %.

The aqueous inkjet ink may also contain a sequestering agent, such as ethylenediaminetetraacetic acid (EDTA).

### Fixer Inks

The present invention utilizes fixer inks, which comprise a fixer dispersed or dissolved in an ink vehicle. The ink vehicle may be any ink vehicle, such as those described above.

The fixer is typically selected from the group consisting of metal salts (e.g. calcium salts) and polyalkylamines (e.g. polyethyleneimine). Suitable calcium salts include, for example, calcium chloride, calcium nitrate etc.

The fixer ink may be colored or colorless. In the case of colored fixer inks, the color may be the same or different than the color of the pigment-based ink. For example, a black fixer ink may be used in combination with a black pigment-based ink. Alternatively, a yellow, magenta or cyan fixer ink may be used in combination with a black pigment-based ink.

Where the fixer ink is colored, the colorant in the fixer ink may be a dye or pigment.

Inkjet dyes suitable for use in the fixer ink are not particularly limited and such dyes will be well-known to the person skilled in the art. By way of example, dyes suitable for use in the fixer ink include include azo dyes (e.g. Food Black 2), metal complex dyes, naphthol dyes, anthraquinone dyes, indigo dyes, carbonium dyes, quinone-imine dyes, xanthene dyes, cyanine dyes, quinoline dyes, nitro dyes, nitroso dyes, benzoquinone dyes, naphthoquinone dyes, phthalocyanine dyes (including naphthalocyanine dyes), and metal phthalocyanine dyes (including metal naphthalocyanine dyes, such as those described in U.S. Pat. No. 7,148,345, the contents of which is herein incorporated by reference).

Specific examples of suitable dyes include: CI Direct Black 4, 9, 11, 17, 19, 22, 32, 80, 151, 154, 168, 171, 194 and 195; CI Direct Blue 1, 2, 6, 8, 22, 34, 70, 71, 76, 78, 86, 142, 199, 200, 201, 202, 203, 207, 218, 236 and 287; CI Direct Red 1, 2, 4, 8, 9, 11, 13, 15, 20, 28, 31, 33, 37, 39, 51, 59, 62, 63, 73, 75, 80, 81, 83, 87, 90, 94, 95, 99, 101, 110, 189, 225 and 227; CI Direct Yellow 1, 2, 4, 8, 11, 12, 26, 27, 28, 33, 34, 41, 44, 48, 86, 87, 88, 132, 135, 142 and 144; CI Food Black 1 and 2; CI Acid Black 1, 2, 7, 16, 24, 26, 28, 31, 48, 52, 63, 107, 112, 118, 119, 121, 172, 194 and 208; CI Acid Blue 1, 7, 9, 15, 22, 23, 27, 29, 40, 43, 55, 59, 62, 78, 80, 81, 90, 102, 104, 111, 185 and 254; CI Acid Yellow 1, 3, 4, 7, 11, 12, 13, 14, 19, 23, 25, 34, 38, 41, 42, 44, 53, 55, 61, 71, 76 and 79; CI Reactive Blue 1, 2, 3, 4, 5, 6, 7, 8, 9, 13, 14, 15, 17, 18, 19, 20, 21, 25, 26, 27, 28, 29, 31, 32, 33, 34, 37, 38, 39, 40, 41, 43, 44 and 46; CI Reactive Red 1, 2, 3, 4, 5, 6, 7, 8, 11, 12, 13, 15, 16, 17, 19, 20, 21, 22, 23, 24, 28, 29, 31, 32, 33, 34, 35, 36, 37, 38, 39, 40, 41, 42, 43, 44, 45, 46, 49, 50, 58, 59, 63, 64, and 180; CI Reactive Yellow 1, 2, 3, 4, 6 7, 11, 12, 13, 14, 15, 16, 17, 18, 22, 23, 24, 25, 26, 27, 37 and 42; CI Reactive Black 1, 3, 4, 5, 6, 8, 9, 10, 12, 13, 14 and 18; Pro-Jet® Fast Cyan 2 (Fujifilm Imaging Colorants); Pro-Jet® Fast Magenta 2 (Fujifilm Imaging Colorants); Pro-Jet® Fast Yellow 2 (Fujifilm Imaging Colorants); and Pro-Jet® Fast Black 2 (Fujifilm Imaging Colorants).

Alternatively, the fixer ink may include a pigment as the colorant. In the case where the fixer ink includes a pigment, the pigment should be stable to aggregation by the fixer. A high degree of stabilization may be provided by a relatively high number of stabilizing surface groups on a surface-modified pigment. Alternatively, a high degree of stabilization may be provided by a particularly stabilizing dispersant employed in combination with a conventional pigment.

The amount of fixer contained in the fixer ink may vary depending on the type of fixer employed. For example, the fixer may comprise 0.01 to 10 wt. % or 0.05 to 5 wt. % of a metal salt (e.g. calcium chloride) and/or 0.01 to 10 wt. % or 0.05 to 5 wt. % of a polyalkylamine. Where alternative fixers are employed, these may be present in the fixer ink in similar quantities.

### Experimental Section

The following experimental section demonstrates the advantages of overprinting fixer inks onto pigment-based ink in Memjet® printheads, compared with underprinting fixer inks

A number of different pigment-based black inks (1K, 2K and 3K) and fixer inks (1F, 2F and 3F) were prepared for testing. Each ink was formulated by weighing ink components into a glass bottle, stirring for 10 minutes and then filtering.

The inks had the following formulations:

### Pigment-Based Black Inks

| | 1K | | 2K | | 3K | |
|---|---|---|---|---|---|---|
| Ethylene glycol | 10 | parts | 10 | parts | 10 | parts |
| 2-pyrrolidinone | 9 | parts | 9 | parts | 9 | parts |
| Glycerol | 3 | parts | 3 | parts | 3 | parts |
| SDP2000 (Sensient) | 5 | parts | | | | |
| IJX455 (Cabot) | | | 5 | parts | | |
| COJ400 (Cabot) | | | | | 5 | parts |
| Surfynol 465 | 0.5 | parts | 0.5 | parts | 0.5 | parts |
| (Air Products) | | | | | | |

| | | | |
|---|---|---|---|
| Water | To 100 parts | To 100 parts | To 100 parts |

### Fixer Inks

| | 1F | | 2F | | 3F | |
|---|---|---|---|---|---|---|
| Ethylene glycol | 10 | parts | 13 | parts | 10 | parts |
| 2-pyrrolidinone | 9 | parts | 9 | parts | 9 | parts |
| Glycerol | 3 | parts | 3 | parts | 3 | parts |
| 1M Calcium Chloride | 3 | parts | 4 | parts | 5 | parts |
| Surfynol 465 | 0.2 | parts | 0.2 | parts | 0.2 | parts |

| | | | |
|---|---|---|---|
| Water | To 100 parts | To 100 parts | To 100 parts |

### Print Test Method

All printing was conducted using a 1600 dpi×1600 dpi in a Memjet® printer having a printhead with 5 color channels (1-5). The printer was plumbed for either overprinting or underprinting of fixer ink as follows:

### Underprinting

Fixer solution (1F to 3F) was plumbed into channel 2 of the printhead.

Black Ink (1K to 3K) was plumbed into channel 4 of the printhead.

Deionized waster was plumbed into channels 1,3 and 5.

### Overprinting

Fixer solution (1F to 3F) was plumbed into channel 4 of the printhead.

Black Ink (1K to 3K) was plumbed into channel 2 of the printhead.

Deionized water was plumbed into channels 1, 3 and 5.

A series of charts were printed that contained 1 cm by 1 cm patches, where channels 2 and 4 were printed dot on dot. At a print speed of 30 pages per minute, the time interval between drop ejections from channels 2 and 4 was about 2.2 ms. The patches contained 100% image density of both channel 2 and channel 4.

Optical density was recorded using ANSI-A standard paper white with 2° angle of illumination from a D50 source.

The results are shown in the Table below.

| | | Pigment- | | |
|---|---|---|---|---|
| Substrate | Fixer Ink | based ink | Print order | OD |
| Office Max All-in-One ® | 3F | 1K | Underprinting fixer | 1.02 |
| Office Max All-in-One ® | 3F | 1K | Overprinting fixer | 1.09 |
| Office Max All-in-One ® | 1K | 1K | | 1.05 |
| | (comparative) | | | |
| Oce Engineering Bond ® | 3F | 1K | Underprinting fixer | 1.04 |
| Oce Engineering Bond ® | 3F | 1K | Overprinting fixer | 1.09 |
| Oce Engineering Bond ® | 1K | 1K | | 1.1 |
| Office Max All-in-One ® | 2F | 2K | Underprinting fixer | 0.76 |
| Office Max All-in-One ® | 2F | 2K | Overprinting fixer | 1.00 |
| Office Max All-in-One ® | 2K | 2K | | 0.94 |
| | (comparative) | | | |
| Oce Engineering Bond ® | 2F | 2K | Underprinting fixer | 0.82 |
| Oce Engineering Bond ® | 2F | 2K | Overprinting fixer | 1.05 |
| Oce Engineering Bond ® | 2K | 2K | | 0.86 |
| | (comparative) | | | |
| Office Max All-in-One ® | 1F | 3K | Underprinting fixer | 1.10 |
| Office Max All-in-One ® | 1F | 3K | Overprinting fixer | 1.18 |
| Office Max All-in-One ® | 3K | 3K | | 0.99 |
| | (comparative) | | | |
| Oce Engineering Bond ® | 1F | 3K | Underprinting fixer | 1.10 |
| Oce Engineering Bond ® | 1F | 3K | Overprinting fixer | 1.17 |
| Oce Engineering Bond ® | 3K | 3K | | 1.03 |

### CONCLUSIONS

The results shown in the Table above show that the optical density of a range of pigment-based black inks printed on a range of substrates is maximized when the fixer ink is overprinted with a period of less than 5 ms. In all cases, superior optical density is observed when overprinting the fixer ink compared to underprinting. Moreover, overprinting the fixer ink generally gave superior optical densities compared with printing using twice the amount of black pigment-based ink (see comparative examples).

This optimization of black optical densities using overprinted fixer ink, when printing at high speeds, was wholly unexpected.

It will, of course, be appreciated that the present invention has been described by way of example only and that modifications of detail may be made within the scope of the invention, which is defined in the accompanying claims.

1. A method of inkjet printing comprising the steps of:
(a) moving a substrate past a printhead;
(b) printing a pigment-based ink onto the substrate from a first color channel of the printhead; and
(c) overprinting a fixer ink onto the pigment-based ink from a second color channel of the printhead,
wherein the fixer ink is overprinted onto the pigment-based ink within a period of less than 5 ms.

2. The method of claim 1, wherein the printhead is a stationary pagewidth printhead, and the substrate is fed past the printhead at a speed in the range of 0.1 to 3 meters per second.

3. The method of claim 1, wherein a distance between the first and second color channels in the printhead is in the range of 50 to 500 microns.

4. The method of claim 1, wherein the fixer ink comprises at least one fixer selected from the group consisting of: a metal salt and a polyamine.

5. The method of claim 4, wherein the metal salt is a calcium salt and the polyamine is polyethyleneimine.

6. The method of claim 1, wherein the fixer ink comprises a colorant selected from the group consisting of: dyes and pigments.

7. The method of claim 1, wherein the pigment-based ink comprises a self-dispersing pigment.

8. The method of claim 1, wherein the pigment-based ink comprises a pigment and a dispersant.

9. The method of claim 1, wherein the pigment-based ink comprises a black pigment.

10. The method of claim 1, wherein the fixer ink is overprinted onto the pigment-based ink within a period in the range of 0.1 to 2.5 ms

11. An inkjet printer comprising:
a stationary printhead having a first color channel for ejecting a fixer ink and a second color channel for ejecting a pigment-based ink; and
a feed mechanism for feeding a substrate past the printhead,
wherein the printer is configured for overprinting the fixer ink onto the pigment-based ink within a period of less than 5 ms.

12. The inkjet printer of claim 11, wherein the feed mechanism is configured to feed the substrate past the printhead at a speed in the range of 0.1 to 3 meters per second.

13. The inkjet printer of claim 11, wherein a distance between the first and second color channels in the printhead is in the range of 50 to 500 microns.

14. The inkjet printer of claim 11, wherein the fixer ink comprises at least one fixer selected from the group consisting of: a metal salt and a polyamine.

15. The inkjet printer of claim 14, wherein the metal salt is a calcium salt and the polyamine is polyethyleneimine.

16. The inkjet printer of claim 11, wherein the fixer ink comprises a colorant selected from the group consisting of: dyes and pigments.

17. The inkjet printer of claim 11, wherein the pigment-based ink comprises a self-dispersing pigment.

18. The inkjet printer of claim 11, wherein the pigment-based ink comprises a pigment and a dispersant.

19. The inkjet printer of claim 11, wherein the pigment-based ink comprises a black pigment.

20. The inkjet printer of claim 11, wherein the fixer ink is overprinted onto the pigment-based ink within a period in the range of 0.1 to 2.5 ms
